(19) United States
(12) Patent Application Publication
(10) Pub. No.: US 2021/0229639 A1
(43) Pub. Date: Jul. 29, 2021

(54) VEHICLE-INSTALLED SENSOR CLEANING APPARATUS

(71) Applicant: TOYOTA JIDOSHA KABUSHIKI KAISHA, Toyota-shi (JP)

(72) Inventor: Ryo SATO, Toyota-shi (JP)

(21) Appl. No.: 17/007,409

(22) Filed: Aug. 31, 2020

(30) Foreign Application Priority Data
Jan. 24, 2020 (JP) 2020-009716

(51) Int. Cl. B60S 1/56; B60W 40/04

(52) U.S. Cl. CPC B60S 1/56; B60W 2554/802; B60W 2555/60; B60W 40/04

(57) ABSTRACT

A vehicle-installed sensor cleaning apparatus is applied to an own vehicle installed with a vehicle-installed sensor. The vehicle-installed sensor cleaning apparatus executes an automatic cleaning process to clean a detection part of the vehicle-installed sensor by a cleaning liquid when an automatic cleaning condition becomes satisfied. The vehicle-installed sensor cleaning apparatus obtains information on a present position of the own vehicle as vehicle information and performs a changing process to change the automatic cleaning condition, depending on the vehicle information.

### BACKGROUND

### Field

The invention relates to a vehicle-installed sensor cleaning apparatus.

### Description of the Related Art

There is known a vehicle installed with sensors which obtain driving assist information used to assist a driver to drive a vehicle. Such known vehicle includes a vehicle installed with a camera sensor which includes a camera which takes images of a view outside of the vehicle and obtains data on the images taken by the camera as the driving assist information. Hereinafter, the sensor installed on the vehicle will be referred to as “the vehicle-installed sensor.”

A lens of the camera of the camera sensor functions as a detection part which detects the driving assist information. When water droplets are on the lens functioning as the detection part, the images taken by the camera are unclear. As a result, the driving assist information having an enough accuracy level cannot be obtained from the images. In general, this will be also applied to the detection part of the vehicle-installed sensor with dirt.

There is known an vehicle-install sensor cleaning apparatus which automatically cleans the detection part of the vehicle-installed sensor by cleaning liquid when the dirt is on the detection part of the vehicle-installed sensor (for example, see JP 2019-123262 A).

While the detection part of the vehicle-installed sensor is being cleaned by the cleaning liquid, the vehicle-installed sensor cannot obtain the driving assist information having a high accuracy level. Therefore, if the vehicle-installed sensor cleaning apparatus cleans the detection part of the vehicle-installed sensor by the cleaning liquid while a moving state of the vehicle needs the driving assist information having the high accuracy level, the driving assist information having the high accuracy level cannot be obtained. As a result, the driver cannot be properly assisted.

### SUMMARY

The invention has been made for solving problems mentioned above. An object of the invention is to provide a vehicle-installed sensor cleaning apparatus which can clean the detection part of the vehicle-installed sensor, ensuring a high detection accuracy level of the vehicle-installed sensor when the high detection accuracy level of the vehicle-installed sensor is required.

A vehicle-installed sensor cleaning apparatus according to the invention is applied to an own vehicle installed with a vehicle-installed sensor. The vehicle-installed sensor cleaning apparatus comprises an electronic control unit configured to execute an automatic cleaning process to clean a detection part of the vehicle-installed sensor by a cleaning liquid when an automatic cleaning condition becomes satisfied. The electronic control unit is configured to obtain information on a present position of the own vehicle as vehicle information and perform a changing process to change the automatic cleaning condition, depending on the vehicle information.

The required detection accuracy level of the vehicle-installed sensor varies, depending on the present position of the own vehicle (i.e., a place where the own vehicle moves at present). According to the invention, the electronic control unit obtains the vehicle information on the present position of the own vehicle and executes the changing process to change the automatic cleaning condition, depending on the vehicle information. Thereby, the electronic control unit can change the automatic cleaning condition to be satisfied at the relatively high detection accuracy level of the vehicle-installed sensor while the required detection accuracy level of the vehicle-installed sensor is low. When the automatic cleaning condition is satisfied, the automatic cleaning process is executed. Thus, the high detection accuracy level of the vehicle-installed sensor can be ensured when the high detection accuracy level of the vehicle-installed sensor is required.

According to an aspect of the invention, the automatic cleaning condition may be a condition that an accuracy index value representing a detection accuracy level of the vehicle-installed sensor is smaller than or equal to a predetermined determination threshold. In this aspect, the changing process may be a process to change the predetermined determination threshold, depending on the vehicle information. According to this aspect of the invention, the automatic cleaning condition can be changed by changing the predetermined determination threshold compared with the accuracy index value.

According to another aspect of the invention, the vehicle information may include a traffic light distance between (i) the present position of the own vehicle and (ii) a traffic light regulating a moving of the own vehicle. According to this aspect of the invention, the automatic cleaning condition can be changed, depending on the traffic light distance.

According to further another aspect of the invention, the electronic control unit may be configured to obtain the traffic light distance, based on a traffic light installation signal transmitted from a transmitter and representing that the traffic light is installed. According to this aspect of the invention, the traffic light distance can be obtained by using the traffic light installation signal transmitted from the transmitter.

According to further another aspect of the invention, the vehicle information may include a traffic light distance between (i) the present position of the own vehicle and (ii) a traffic light regulating a moving of the own vehicle. In this aspect, the automatic cleaning condition may be a condition that an accuracy index value representing a detection accuracy level of the vehicle-installed sensor is smaller than or equal to a predetermined determination threshold. Further, in this aspect, the changing process may be a process to change the predetermined determination threshold, depending on the traffic light distance. Further, in this aspect, the electronic control unit may be configured to set a first threshold as the predetermined determination threshold when the traffic light distance is longer than or equal to a first distance. Further, the electronic control unit may be configured to set a second threshold larger than the first threshold as the predetermined determination threshold when the traffic light distance is shorter than the first distance and longer than or equal to a second distance. Further, the electronic control unit may be configured to set a third threshold smaller than the first threshold as the predetermined determination threshold when the traffic light distance is shorter than the second distance.

According to this aspect of the invention, when the traffic light distance is shorter than the first distance and longer than or equal to the second distance, the predetermined determination threshold is set to the second threshold, i.e., a larger value. Therefore, the automatic cleaning condition is satisfied at the relatively high detection accuracy level of the vehicle-installed sensor. As a result, the automatic cleaning process is executed at the relatively high detection accuracy level of the vehicle-installed sensor. Thus, the high detection accuracy level of the vehicle-installed sensor can be ensured when the traffic light distance becomes shorter than the second distance.

According to further another aspect of the invention, the electronic control unit may be configured to determine that the traffic light distance is longer than or equal to the first distance when the electronic control unit does not receive a traffic light installation signal transmitted from a transmitter and representing that the traffic light is installed. According to this aspect of the invention, whether the traffic light distance is longer than or equal to the first distance, can be determined by using the traffic light installation signal transmitted from the transmitter.

According to further another aspect of the invention, the electronic control unit may be configured to determine that the traffic light distance is longer than or equal to the first distance when the electronic control unit does not receive a traffic light installation signal transmitted from a transmitter and representing that the traffic light is installed. Further, the electronic control unit may be configured to determine that the traffic light distance is shorter than the first distance and longer than or equal to the second distance when (i) the electronic control unit receives the traffic light installation signal, and (ii) a distance which the own vehicle has moved since the electronic control unit starts to receive the traffic light installation signal, is shorter than or equal to a predetermined distance. Further, the electronic control unit may be configured to determine that the traffic light distance is shorter than the second distance when the distance which the own vehicle has moved since the electronic control unit starts to receive the traffic light installation signal, is longer than the predetermined distance.

According to this aspect of the invention, whether the traffic light distance is longer than or equal to the first distance and whether the traffic light distance is longer than or equal to the second distance, can be determined by using the traffic light installation signal transmitted from the transmitter.

According to further another aspect of the invention, the electronic control unit may be configured to execute a manual cleaning process to clean the detection part by the cleaning liquid when (i) the traffic light distance is longer than or equal to the second distance, and (ii) a switch to request to clean the detection part is operated.

According to this aspect of the invention, the manual cleaning process is not executed when the traffic light distance is shorter than the second distance. Thus, the detection accuracy level of the vehicle-installed sensor can be prevented from being decreased due to that the cleaning liquid is on the detection part when the traffic light distance is shorter than the second distance.

According to further another aspect of the invention, the vehicle information may include a traffic light distance between (i) the present position of the own vehicle and (ii) a traffic light regulating a moving of the own vehicle. In this aspect, the automatic cleaning condition may be a condition that (i) the traffic light distance is shorter than a first distance, and (ii) an accuracy index value representing a detection accuracy level of the vehicle-installed sensor is smaller than or equal to a predetermined determination threshold. According to this aspect of the invention, the automatic cleaning process is not executed when the traffic light distance is longer than or equal to the first distance. Thus, an amount of the consumed cleaning liquid can be reduced.

According to further another aspect of the invention, the vehicle information may include an area distance between (i) the present position of the own vehicle and (ii) an area where a detection accuracy level of the vehicle-installed sensor higher than or equal to a predetermined accuracy level is required. According to this aspect of the invention, the automatic cleaning condition can be changed, depending on the required detection accuracy level of the vehicle-installed sensor.

According to further another aspect of the invention, the area may be an area where the own vehicle is presumed to be braked. When the own vehicle is braked, the high detection accuracy level of the vehicle-installed sensor may be required. According to this aspect of the invention, the high detection accuracy level of the vehicle-installed sensor can be ensured while the own vehicle moves in an area where the high detection accuracy level of the vehicle-installed sensor may be required.

According to further another aspect of the invention, the vehicle information may include an area distance between (i) the present position of the own vehicle and (ii) an area where a detection accuracy level of the vehicle-installed sensor higher than or equal to a predetermined accuracy level is required. In this aspect, the automatic cleaning condition may be a condition that an accuracy index value representing a detection accuracy level of the vehicle-installed sensor is smaller than or equal to a predetermined determination threshold. In this aspect, the changing process may be a process to change the predetermined determination threshold, depending on the area distance. In this aspect, the electronic control unit may be configured to set a first threshold as the predetermined determination threshold when the area distance is longer than or equal to a first distance. Further, the electronic control unit may be configured to set a second threshold larger than the first threshold as the predetermined determination threshold when the area distance is shorter than the first distance and longer than or equal to a second distance. Further, the electronic control unit may be configured to set a third threshold smaller than the first threshold as the predetermined determination threshold when the area distance is shorter than the second distance.

According to this aspect of the invention, when the area distance is shorter than the first distance and longer than or equal to the second distance, the predetermined determination threshold is set to the second threshold, i.e., a larger value. Therefore, the automatic cleaning condition is satisfied at the relatively high detection accuracy level of the vehicle-installed sensor. As a result, the automatic cleaning process is executed at the relatively high detection accuracy level of the vehicle-installed sensor. Thus, the high detection accuracy level of the vehicle-installed sensor can be ensured when the area distance becomes smaller than the second distance.

According to further another aspect of the invention, the vehicle information may include an area distance between (i) the present position of the own vehicle and (ii) an area where a detection accuracy level of the vehicle-installed sensor higher than or equal to a predetermined accuracy level is required. In this aspect, the automatic cleaning condition may be a condition that (i) the area distance is shorter than a first distance, and (ii) an accuracy index value representing the detection accuracy level of the vehicle-installed sensor is smaller than or equal to a predetermined determination threshold.

According to this aspect of the invention, when the area distance is longer than or equal to the first distance, the automatic cleaning process is not executed. Thus, the amount of the consumed cleaning liquid can be reduced.

According to further another aspect of the invention, the vehicle information may include an area distance between (i) the present position of the own vehicle and (ii) an area where a detection accuracy level of the vehicle-installed sensor higher than or equal to a predetermined accuracy level is required. In this aspect, the automatic cleaning condition may be a condition that an accuracy index value representing a detection accuracy level of the vehicle-installed sensor becomes smaller than or equal to a predetermined determination threshold. In this aspect, the changing process may be a process to change the predetermined determination threshold, depending on the area distance. In this aspect, the electronic control unit may be configured to set a first threshold as the predetermined determination threshold when the area distance is longer than or equal to a distance presumed for the own vehicle to move until cleaning the detection part is finished. Further, the electronic control unit may be configured to set a second threshold larger than the first threshold as the predetermined determination threshold when the area distance becomes equal to the distance presumed for the own vehicle to move until cleaning the detection part is finished and immediately afterwards, set a third threshold smaller than the first threshold as the predetermined determination threshold.

According to this aspect of the invention, the predetermined determination threshold is set to the second threshold, i.e., a larger value only at a point of time when the area distance becomes equal to the distance presumed for the own vehicle to move until cleaning the detection part is finished. As a result, the automatic cleaning condition is satisfied at the relatively high detection accuracy level of the vehicle-installed sensor only at a point of time when the area distance becomes equal to the distance presumed for the own vehicle to move until cleaning the detection part is finished. Thus, the amount of the consumed cleaning liquid can be reduced.

According to further another aspect of the invention, the electronic control unit may be configured to determine whether the automatic cleaning condition is satisfied when the own vehicle moves. Further, the electronic control unit may be configured to stop determining whether the automatic cleaning condition is satisfied when the own vehicle is stopped.

When the own vehicle stops, there may be a walking person or the like around the own vehicle. When (i) the walking person or the like is around the own vehicle, and (ii) the automatic cleaning process is executed, the cleaning liquid may spatter to the walking person or the like. According to this aspect of the invention, whether the automatic cleaning condition is satisfied, is not determined when the own vehicle stops. As a result, the automatic cleaning process is not executed when the own vehicle stops. Thus, the cleaning liquid can be prevented from spattering to the walking person or the like.

According to further another aspect of the invention, the vehicle-installed sensor may be a sensor which detects a situation behind the own vehicle. In this aspect, the electronic control unit may be configured to change the automatic cleaning condition to be satisfied at a higher detection accuracy level of the vehicle-installed sensor when the vehicle-installed sensor detects a following vehicle which approaches the own vehicle from behind the own vehicle at a moving speed higher than or equal to a predetermined moving speed.

When the following vehicle approaches to the own vehicle from behind the own vehicle, the driver is likely to need information on the situation behind the own vehicle. According to this aspect of the invention, the automatic cleaning condition is changed to be satisfied at the relatively high detection accuracy level of the vehicle-installed sensor when (i) the vehicle-installed sensor is the sensor which detects the situation behind the own vehicle, and (ii) the vehicle-installed sensor detects the following vehicle which approaches the own vehicle from behind the own vehicle at the predetermined moving speed or higher. Thus, the high detection accuracy level of the vehicle-installed sensor can be ensured when the driver is likely to need the information on the situation behind the own vehicle.

Elements of the invention are not limited to elements of embodiments and modified examples of the invention described along with the drawings. The other objects, features and accompanied advantages of the invention can be easily understood from the embodiments and the modified examples of the invention.

### BRIEF DESCRIPTION OF THE DRAWINGS

FIG. 1 is a view which shows a vehicle-installed sensor cleaning apparatus according to an embodiment of the invention and a vehicle installed with the vehicle-installed sensor cleaning apparatus.

FIG. 2 is a view which describes operations of the vehicle-installed sensor cleaning apparatus according to the embodiment of the invention.

FIG. 3 is a view which shows a flowchart of a routine executed by a CPU of an ECU according to the embodiment of the invention.

FIG. 4 is a view which shows a flowchart of a routine executed by the CPU.

FIG. 5 is a view which shows a flowchart of a routine executed by the CPU.

### DESCRIPTION OF THE EMBODIMENTS

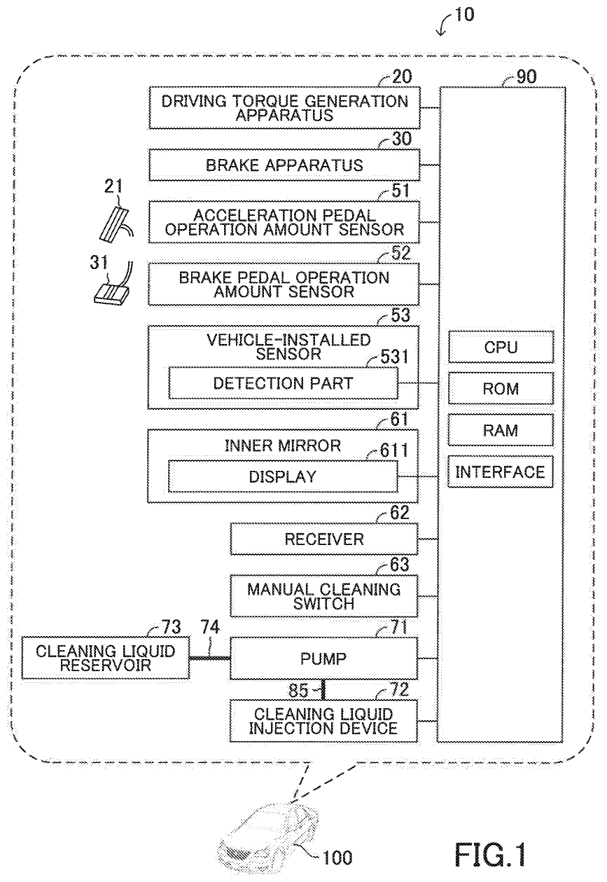

Below, a vehicle-installed sensor cleaning apparatus according to an embodiment of the invention will be described with reference to the drawings. As shown in FIG. 1, the vehicle-installed sensor cleaning apparatus 10 according to the embodiment of the invention is installed on a vehicle 100. The vehicle 100 is also installed with a driving torque generation apparatus 20 and a brake apparatus 30.

The driving torque generation apparatus 20 generates a vehicle driving torque to be applied to driven wheels of wheels of the vehicle 100 to drive the vehicle 100. In this embodiment, the driving torque generation apparatus 20 includes an internal combustion engine. Alternatively, the driving torque generation apparatus 20 may include at least one electric motor. Alternatively, the driving torque generation apparatus 20 may include the internal combustion engine and the at least one electric motor. The brake apparatus 30 generates braking forces to be applied to the wheels of the vehicle 100 to brake the vehicle 100.

Further, the vehicle 100 is installed with a control device which controls activations of the driving torque generation apparatus 20 and the brake apparatus 30. The control device includes an ECU 90. The ECU 90 includes a CPU, a ROM, a RAM, and an interface. The vehicle-installed sensor cleaning apparatus 10 includes the ECU 90 as a component thereof.

As shown in FIG. 1, the driving torque generation apparatus 20 and the brake apparatus 30 are electrically connected to the ECU 90. The ECU 90 can control the vehicle driving torque generated by the driving torque generation apparatus 20 by controlling an activation state of the driving torque generation apparatus 20. Also, the ECU 90 can control the braking force generated by the brake apparatus 30 by controlling an activation state of the brake apparatus 30.

Further, the vehicle 100 is installed with an acceleration pedal operation amount sensor 51 and a brake pedal operation amount sensor 52. The acceleration pedal operation amount sensor 51 and the brake pedal operation amount sensor 52 are electrically connected to the ECU 90.

The acceleration pedal operation amount sensor 51 detects an amount of an operation applied to an acceleration pedal 21 of the vehicle 100 and sends a signal representing the detected amount to the ECU 90. The ECU 90 obtains the amount of the operation applied to the acceleration pedal 21 as an acceleration pedal operation amount AP, based on the received signal and controls the activation state of the driving torque generation apparatus 20, based on the obtained acceleration pedal operation amount AP.

The brake pedal operation amount sensor 52 detects an amount of an operation applied to a brake pedal 31 of the vehicle 100 and sends a signal representing the detected amount to the ECU 90. The ECU 90 obtains the amount of the operation applied to the brake pedal 31 as a brake pedal operation amount BP, based on the received signal and controls the activation state of the brake apparatus 30, based on the obtained brake pedal operation amount BP.

Further, the vehicle-installed sensor cleaning apparatus 10 is installed with a vehicle-installed sensor 53, an inner mirror 61, a receiver 62, a manual cleaning switch 63, a pump 71, a cleaning liquid injection device 72, and a cleaning liquid reservoir 73. The vehicle-installed sensor 53, the inner mirror 61, the receiver 62, the manual cleaning switch 63, the pump 71, and the cleaning liquid injection device 72 are electrically connected to the ECU 90. The cleaning liquid reservoir 73 stores cleaning liquid used to clean the vehicle-installed sensor 53. The cleaning liquid reservoir 73 is fluidically connected to the pump 71 via a cleaning liquid pipe 74, and the pump 71 is fluidically connected to the cleaning liquid injection device 72 via a cleaning liquid pipe 75.

The vehicle-installed sensor cleaning apparatus 10 includes the manual cleaning switch 63, the pump 71, the cleaning liquid injection device 72, and the cleaning liquid reservoir 73 as components thereof.

The vehicle-installed sensor 53 detects a situation surrounding the vehicle 100. Information on the situation detected by the vehicle-installed sensor 53 is used as driving assist information used to assist a driving operation of a driver of the vehicle 100. The vehicle-installed sensor 53 includes a detection part 531 which detects the situation surrounding the vehicle 100. In this embodiment, the vehicle-installed sensor 53 is a camera sensor including a CCD camera. Therefore, in this embodiment, the detection part 531 is a lens of the CCD camera.

The vehicle-installed sensor 53 is mounted on the vehicle 100 to take images of a view behind the vehicle 100 by the CCD camera. The vehicle-installed sensor 53 sends data on the images taken by the CCD camera to the ECU 90. The ECU 90 displays the image behind the vehicle 100 on a display 611 of the inner mirror 61, based on the received data.

The inner mirror 61 is mounted on the vehicle 100 at a position in front of a driver seat of the vehicle 100 such that the driver can see the inner mirror 61. The driver can recognize the situation behind the vehicle 100 by seeing the image displayed on the display 611 of the inner mirror 61 while the driver drives the vehicle 100.

The vehicle-installed sensor 53 may be a camera sensor which includes the CCD camera and is mounted on the vehicle 100 to take images of a view ahead of the vehicle 100 by the CCD camera.

For example, when the vehicle-installed sensor 53 is a camera sensor which takes the images of the view ahead of the vehicle 100 by the CCD camera, the ECU 90 stores the received data on the images taken by the CCD camera in a data recorder of a dashcam. Alternatively, when the ECU 90 determines that there is an object ahead the vehicle 100, based on the received data on the images taken by the CCD camera, the ECU 90 executes a control to prevent the vehicle 100 from contacting to the object.

The vehicle-installed sensor 53 may be a radar sensor, a clearance sonar, or a LiDAR mounted on the vehicle 100 to detect the object around the vehicle 100. For example, when the ECU 90 recognizes the object around the vehicle 100 by the radar sensor, the clearance sonar, or the LiDAR, the ECU 90 execute the control to prevent the vehicle 100 from contacting to the object.

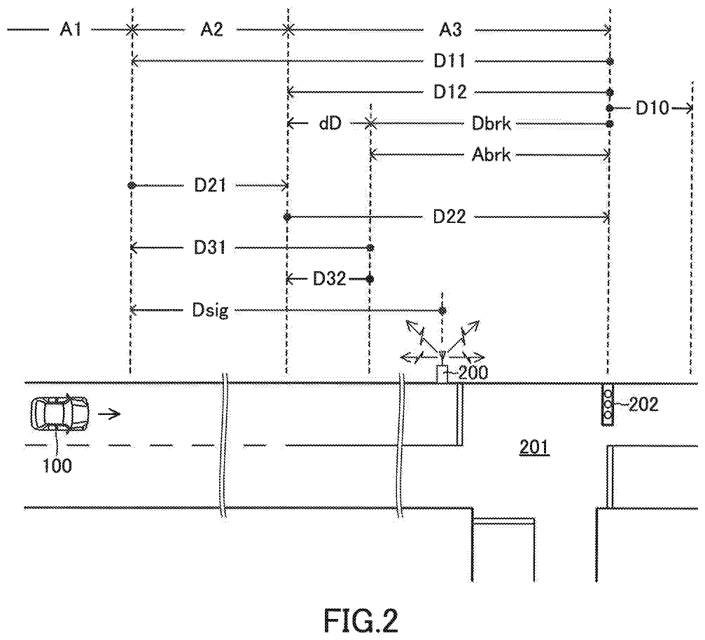

The receiver 62 receives signals transmitted from a transmitter 200 (or a so-called road-side communication apparatus). As shown in FIG. 2, the transmitter 200 is installed, for example, around a traffic intersection 201 with traffic lights 202. In this case, the transmitter 200 transmits signals representing lighting states of the traffic lights 202. The receiver 62 receives the signals. When the receiver 62 receives the signals transmitted from the transmitter 200, the receiver 62 sends the received signals to the ECU 90.

The ECU 90 can recognize whether any one of the traffic lights 202 is installed ahead of the vehicle 100 in a moving direction of the vehicle 100 to regulate a moving of the vehicle 100, based on the received signals. Hereinafter, the traffic light 202 regulating the moving of the vehicle 100 will be referred to as “the target traffic light 202tgt.” One of the signals transmitted from the transmitter 200 is a traffic light installation signal representing that there is the target traffic light 202tgt. Further, the ECU 90 can recognize whether a red or green signal of the target traffic light 202tgt is lighted.

When a distance between the receiver 62 and the transmitter 200 is shorter than or equal to a certain distance Dsig, the receiver 62 receives the signals transmitted from the transmitter 200. Therefore, the distance between the receiver 62 and the transmitter 200 corresponds to the distance Dsig when the receiver 62 starts to receive the signals transmitted from the transmitter 200. Therefore, the ECU 90 can presume the distance between the vehicle 100 and the traffic light 202, based on the distance Dsig.

The transmitter 200 may be configured to transmit signals representing that stop lines are provided on roads. If the transmitter 200 is configured to transmit the signals representing that the stop lines are provided on the roads, the receiver 62 sends the received signal representing that the stop lines are provided on the roads to the ECU 90. The ECU 90 can recognize the stop line ahead of the vehicle 100 in the moving direction of the vehicle 100 to regulate the moving of the vehicle 100, based on the received signals.

The manual cleaning switch 63 is operated by the driver of the vehicle 100. When the manual cleaning switch 63 is operated by the driver, the manual cleaning switch 63 sends a signal representing that the manual cleaning switch 63 is operated to the ECU 90. When the ECU 90 receives the signal, the ECU 90 determines that the manual cleaning switch 63 is operated.

The ECU 90 can control activation states of the pump 71 and the cleaning liquid injection device 72. When the pump 71 is activated by the ECU 90, the pump 71 takes the cleaning liquid from the cleaning liquid reservoir 73 via the cleaning liquid pipe 74 and supplies the cleaning liquid to the cleaning liquid injection device 72 via the cleaning liquid pipe 75. When the cleaning liquid injection device 72 is activated while the cleaning liquid is supplied to the cleaning liquid injection device 72 by the pump 71, the cleaning liquid injection device 72 injects the cleaning liquid. The cleaning liquid injection device 72 is provided at a position to put the injected cleaning liquid on the detection part 531 of the vehicle-installed sensor 53. In this embodiment, the vehicle-installed sensor 53 is the camera sensor. Thus, the cleaning liquid injection device 72 is provided at a position to put the injected cleaning liquid on the lens of the camera of the camera sensor. When the cleaning liquid is put on the detection part 531 of the vehicle-installed sensor 53, the detection part 531 of the vehicle-installed sensor 53 is cleaned by the cleaning liquid.

<Summary of Operations of Vehicle-Installed Sensor Cleaning Apparatus>

Next, a summary of operations of the vehicle-installed sensor cleaning apparatus 10 will be described. When the detection part 531 of the vehicle-installed sensor 53 becomes dirty due to water droplets and the like on the detection part 531 of the vehicle-installed sensor 53, a detection accuracy level of the vehicle-installed sensor 53 decreases. For example, when (i) the vehicle-installed sensor 53 is the camera sensor, and (ii) the lens of the CCD camera corresponding to the detection part 531 becomes dirty, the detection accuracy level of the CCD camera decreases. As a result, the images taken by the CCD camera may be smudgy. If the images are smudgy, the images of the view behind the vehicle 100 displayed on the display 611 of the inner mirror 61 may be smudgy. If the images on the display 611 is smudgy, the driver may not properly recognize the situation behind the vehicle 100 by seeing the inner mirror 61.

The vehicle-installed sensor cleaning apparatus 10 executes an automatic cleaning process to clean the detection part 531 of the vehicle-installed sensor 53 by the cleaning liquid when an automatic cleaning condition becomes satisfied. The automatic cleaning process is a process to activate the pump 71 and the cleaning liquid injection device 72 to inject the cleaning liquid to the detection part 531 of the vehicle-installed sensor 53 from the cleaning liquid injection device 72.

The vehicle-installed sensor cleaning apparatus 10 obtains a value representing the detection accuracy level of the vehicle-installed sensor 53 as an accuracy index value P as described below.

The image provided from the vehicle-installed sensor 53 includes images of figures and letters. The vehicle-installed sensor cleaning apparatus 10 determines whether the image includes the figures or the letters which can be clearly recognized. When the vehicle-installed sensor cleaning apparatus 10 determines that the image includes the figures or the letters which can be clearly recognized, the vehicle-installed sensor cleaning apparatus 10 obtains sizes of the figures or the letters which can be clearly recognized. The vehicle-installed sensor cleaning apparatus 10 has preliminarily memorized a relationship between the sizes of the figures or the letters which can be clearly recognized and the accuracy index value P. The vehicle-installed sensor cleaning apparatus 10 obtains the accuracy index value P, based on (i) the size of the smallest figure or the smallest letter which can be clearly recognized and (ii) the relationship preliminarily memorized. The obtained accuracy index value P increases as the size of the smallest figure or the smallest letter decreases.

When the accuracy index value P is or becomes smaller than or equal to a predetermined determination threshold Pth, the vehicle-installed sensor cleaning apparatus 10 determines that the automatic cleaning condition becomes satisfied. When the vehicle-installed sensor cleaning apparatus 10 determines that the automatic cleaning condition becomes satisfied, the vehicle-installed sensor cleaning apparatus 10 executes the automatic cleaning process.

When (i) there is the target traffic light 202tgt, and (ii) the vehicle 100 approaches the target traffic light 202tgt, the driver may operate the brake pedal 31 to decelerate the vehicle 100. When the driver operates the brake pedal 31, the driver may check the situation behind the vehicle 100 by the inner mirror 61. Therefore, when (i) there is the target traffic light 202tgt, and (ii) the detection part 531 of the vehicle-installed sensor 53 is needed to be cleaned by the cleaning liquid, cleaning the detection part 531 by the cleaning liquid is desirably finished before the driver starts to operate the brake pedal 31, i.e., before the driver sees the inner mirror 61.

As shown in FIG. 2, the vehicle-installed sensor cleaning apparatus 10 has set a braking area Abrk, a first area A1, a second area A2, and a third area A3 as areas where the vehicle 100 moves.

The braking area Abrk is an area between (i) a point of a predetermined distance Dbrk before the target traffic light 202tgt and (ii) the target traffic light 202tgt. In other words, the braking area Abrk is an area having a distance Dtgt to the target traffic light 202tgt smaller than the predetermined distance Dbrk.

The braking area Abrk is an area where the driver may operate the brake pedal 31 to brake the vehicle 100 in response to a lighting state of the target traffic light 202tgt. In other words, the braking area Abrk is an area where the driver may see the image displayed on the display 611 of the inner mirror 61. In other words, the braking area Abrk is an area where the detection accuracy level of the vehicle-installed sensor 53 larger than or equal to a predetermined accuracy level is required. In other words, the braking area Abrk is an area where information on the situation surrounding the vehicle 100 detected by the vehicle-installed sensor 53 is likely to be needed.

The braking area Abrk may be an area between (i) the point of the predetermined distance Dbrk before the target traffic light 202tgt and (ii) a point of a predetermined distance D10 after the target traffic light 202tgt. Hereinafter, the predetermined distance D10 will be referred to as “the predetermined traffic light distance D10.” The predetermined traffic light distance D10 is a distance from the target traffic light 202tgt to a point where the driver may operate the brake pedal 31 to brake the vehicle 100.

The first area A1 is an area before a point of a predetermined distance D11 before the target traffic light 202tgt. In other words, the first area A1 is an area having the distance Dtgt to the target traffic light 202tgt longer than or equal to the predetermined distance D11. The predetermined distance D11 is longer than the predetermined distance Dbrk. Hereinafter, the predetermined distance D11 will be referred to as “the first traffic light distance D11.”

The second area A2 is an area between (i) a point of the first traffic light distance D11 before the target traffic light 202tgt and (ii) a point of a predetermined distance D12 before the target traffic light 202tgt. In other words, the second area A2 is an area having the distance Dtgt to the target traffic light 202tgt shorter than the first traffic light distance D11 and longer than or equal to the predetermined distance D12. The predetermined distance D12 is shorter than the first traffic light distance D11. The predetermined distance D12 is longer than the predetermined distance Dbrk by a distance dD. The distance dD is a distance presumed for the vehicle 100 to move until the cleaning liquid is removed from the detection part 531 after the cleaning liquid is injected to the detection part 531. In other words, the distance dD is a distance presumed for the vehicle 100 to move until cleaning the detection part 531 by the cleaning liquid is finished. The distance dD may be a constant distance, independently of a moving speed of the vehicle 100. Alternatively, the distance dD may be a distance which increases as the moving speed of the vehicle 100 increases. Hereinafter, the predetermined distance D12 will be referred to as “the second traffic light distance D12.”

The third area A3 is an area between (i) a point of the second traffic light distance D12 before the target traffic light 202tgt and (ii) the target traffic light 202tgt. In other words, the third area A3 is an area having the distance Dtgt to the target traffic light 202tgt shorter than the second traffic light distance D12.

The third area A3 may be an area between (i) the point of the second traffic light distance D12 before the target traffic light 202tgt and (i) the point of the predetermined traffic light distance D10 after the target traffic light 202tgt.

The vehicle-installed sensor cleaning apparatus 10 determines whether the vehicle 100 moves in the first area A1, the second area A2, or the third area A3, based on a distance Ds between the vehicle 100 and the target traffic light 202tgt as described below. Hereinafter, the distance Ds will be referred to as “the traffic light distance Ds.”

In particular, when the vehicle-installed sensor cleaning apparatus 10 does not receive the signal transmitted from the transmitter 200, the vehicle-installed sensor cleaning apparatus 10 determines that the traffic light distance Ds is longer than or equal to the first traffic light distance D11. In this case, the vehicle-installed sensor cleaning apparatus 10 determines that the vehicle 100 moves in the first area A1.

When the vehicle-installed sensor cleaning apparatus 10 starts to receive the signal transmitted from the transmitter 200, the vehicle-installed sensor cleaning apparatus 10 determines that the traffic light distance Ds becomes equal to the first traffic light distance D11. In this case, the vehicle-installed sensor cleaning apparatus 10 determines that the vehicle 100 enters in the second area A2.

The vehicle-installed sensor cleaning apparatus 10 determines that the traffic light distance Ds is smaller than the first traffic light distance D11 and longer than or equal to the second traffic light distance D12 until the vehicle 100 moves a predetermined distance D21 after the vehicle-installed sensor cleaning apparatus 10 determines that the vehicle 100 enters in the second area A2. In this case, the vehicle-installed sensor cleaning apparatus 10 determines that the vehicle 100 moves in the second area A2. The vehicle-installed sensor cleaning apparatus 10 obtains a distance which the vehicle 100 moves, based on the moving speed of the vehicle 100 and an elapsed amount of time. Hereinafter, the predetermined distance D21 will be referred to as “the first moving distance D21.”

When the vehicle 100 moves the first moving distance D21 after the vehicle 100 enters in the second area A2, the vehicle-installed sensor cleaning apparatus 10 determines that the traffic light distance Ds becomes equal to the second traffic light distance D12. In this case, the vehicle-installed sensor cleaning apparatus 10 determines that the vehicle 100 enters in the third area A3.

The vehicle-installed sensor cleaning apparatus 10 determines that the traffic light distance Ds is smaller than the second traffic light distance D12 until the vehicle 100 moves a predetermined distance D22 after the vehicle-installed sensor cleaning apparatus 10 determines that the vehicle 100 enters in the third area A3. In this case, the vehicle-installed sensor cleaning apparatus 10 determines that the vehicle 100 moves in the third area A3. Hereinafter, the predetermined distance D22 will be referred to as “the second moving distance D22.”

When the vehicle 100 moves the second moving distance D22 after the vehicle 100 enters in the third area A3, the vehicle-installed sensor cleaning apparatus 10 determines that the traffic light distance Ds becomes zero. In particular, the vehicle-installed sensor cleaning apparatus 10 determines that the vehicle 100 reaches the target traffic light 202tgt. In this case, the vehicle-installed sensor cleaning apparatus 10 determines that the vehicle 100 moves out of the third area A3.

The vehicle-installed sensor cleaning apparatus 10 may be configured to set the first area A1, the second area A2, and the third area A3 on the basis of the stop line regulating the moving of the vehicle 100. Hereinafter, the stop line regulating the moving of the vehicle 100 will be referred to as “the target stop line.”

The vehicle-installed sensor cleaning apparatus 10 may be configured to obtain a present position of the vehicle 100 by using GPS signals and obtain the traffic light distance Ds by using the obtained present position of the vehicle 100 and map information.

The vehicle-installed sensor cleaning apparatus 10 sets the predetermined determination threshold Pth to a predetermined value or a first threshold P1 when the vehicle 100 moves in the first area A1. In other words, the vehicle-installed sensor cleaning apparatus 10 sets the predetermined determination threshold Pth to the first threshold P1 when the traffic light distance Ds is longer than or equal to the first traffic light distance D11. In other words, the vehicle-installed sensor cleaning apparatus 10 sets the predetermined determination threshold Pth to the first threshold P1 when a distance Da between the vehicle 100 and the braking area Abrk is longer than or equal to a first area distance D31 (see FIG. 2). Hereinafter, the distance Da will be referred to as “the area distance Da.”

In this embodiment, the first threshold P1 is, for example, a lower limit value of the accuracy index value P which enables the driver to recognize the largest figure or letter on a number plate of the following vehicle displayed in the inner mirror 61.

When the accuracy index value P becomes smaller than or equal to the first threshold P1 while the vehicle 100 moves in the first area A1, the vehicle-installed sensor cleaning apparatus 10 determines that the automatic cleaning condition becomes satisfied. In other words, the vehicle-installed sensor cleaning apparatus 10 determines to need to clean the detection part 531 of the vehicle-installed sensor 53. In this case, the vehicle-installed sensor cleaning apparatus 10 executes the automatic cleaning process. Thereby, the detection part 531 is cleaned. As a result, the detection accuracy level of the vehicle-installed sensor 53 increases.

An amount of the cleaning liquid injected from the cleaning liquid injection device 72 by the automatic cleaning process may be suitably set. The amount of the cleaning liquid injected from the cleaning liquid injection device 72 by the automatic cleaning process may be set to a constant amount, independently of the accuracy index value P or may be set to an amount varying, depending on the accuracy index value P of a point of time when the automatic cleaning process starts to be executed. When the amount of the cleaning liquid injected from the cleaning liquid injection device 72 by the automatic cleaning process is set to the amount varying, depending on the accuracy index value P of the point of time when the automatic cleaning process starts to be executed, the amount of the cleaning liquid injected from the cleaning liquid injection device 72 by the automatic cleaning process may be set to an amount which increases as the accuracy index value P at the point of time when the automatic cleaning process is executed, decreases.

The number of times to inject the cleaning liquid from the cleaning liquid injection device 72 by the automatic cleaning process may be suitably set. The number of times to inject the cleaning liquid from the cleaning liquid injection device 72 by the automatic cleaning process may be set a constant value, independently of the total amount of the cleaning liquid injected from the cleaning liquid injection device 72 by the automatic cleaning process. Alternatively, the number of times to inject the cleaning liquid from the cleaning liquid injection device 72 by the automatic cleaning process may be set to a value varying, depending on the total amount of the cleaning liquid injected from the cleaning liquid injection device 72 by the automatic cleaning process. When the number of times to inject the cleaning liquid from the cleaning liquid injection device 72 by the automatic cleaning process is set to a value varying, depending on the total amount of the cleaning liquid injected from the cleaning liquid injection device 72 by the automatic cleaning process, the number of times to inject the cleaning liquid from the cleaning liquid injection device 72 by the automatic cleaning process is set, for example to a value which increases as the total amount of the cleaning liquid injected from the cleaning liquid injection device 72 by the automatic cleaning process, increases.

When the vehicle 100 enters in the second area A2 from the first area A1, the vehicle-installed sensor cleaning apparatus 10 sets the predetermined determination threshold Pth to a second threshold P2 larger than the first threshold P1. In other words, when the traffic light distance Ds is shorter than the first traffic light distance D11 and longer than or equal to the second traffic light distance D12, the vehicle-installed sensor cleaning apparatus 10 sets the predetermined determination threshold Pth to the second threshold P2. In other words, when the area distance Da is shorter than the first area distance D31 and longer than or equal to a second area distance D32 (see FIG. 2), the vehicle-installed sensor cleaning apparatus 10 sets the predetermined determination threshold Pth to the second threshold P2. Thereby, the predetermined determination threshold Pth is set to a larger value. As a result, the automatic cleaning condition is satisfied at the relatively high detection accuracy level of the vehicle-installed sensor 53. Thus, the automatic cleaning process is executed at the relatively high detection accuracy level of the vehicle-installed sensor 53.

In this embodiment, the second threshold P2 is, for example, a lower limit value of the accuracy index value P which enables the driver to recognize the smallest figure or letter on the number plate of the following vehicle displayed in the inner mirror 61.

When (i) the vehicle 100 enters in the second area A2 from the first area A1, and (ii) the accuracy index value P is smaller than or equal to the second threshold P2, the vehicle-installed sensor cleaning apparatus 10 determines that the automatic cleaning condition becomes satisfied. In this case, the vehicle-installed sensor cleaning apparatus 10 executes the automatic cleaning process. Thereby, the detection part 531 is cleaned. As a result, the detection accuracy level of the vehicle-installed sensor 53 increases.

Even when the accuracy index value P is larger than the second threshold P2 when the vehicle 100 enters in the second area A2 from the first area A1, the accuracy index value P may become smaller than or equal to the second threshold P2 while the vehicle 100 is moving in the second area A2. In this case, the vehicle-installed sensor cleaning apparatus 10 determines that the automatic cleaning condition becomes satisfied. In this case, the vehicle-installed sensor cleaning apparatus 10 executes the automatic cleaning process. Thereby, the detection part 531 is cleaned. As a result, the detection accuracy level of the vehicle-installed sensor 53 increases.

When the vehicle 100 enters in the third area A3 from the second area A2, the vehicle-installed sensor cleaning apparatus 10 sets the predetermined determination threshold Pth to a third threshold P3 smaller than the first threshold P1. In other words, when the traffic light distance Ds is shorter than the second traffic light distance D12, the vehicle-installed sensor cleaning apparatus 10 sets the predetermined determination threshold Pth to the third threshold P3. In other words, when the area distance Da is shorter than the second area distance D32, the vehicle-installed sensor cleaning apparatus 10 sets the predetermined determination threshold Pth to the third threshold P3. Thereby, the predetermined determination threshold Pth is set to a smaller value. Thus, the automatic cleaning condition is satisfied at the relatively low detection accuracy level of the vehicle-installed sensor 53. As a result, the automatic cleaning process is executed at the relatively low detection accuracy level of the vehicle-installed sensor 53.

In this embodiment, the third threshold P3 is, for example, a lower limit value of the accuracy index value P which enables the driver to recognize the following vehicle displayed in the inner mirror 61.

When the accuracy index value P becomes smaller than or equal to the third threshold P3 while the vehicle 100 is moving in the third area A3, the vehicle-installed sensor cleaning apparatus 10 determines that the automatic cleaning condition becomes satisfied. In this case, the vehicle-installed sensor cleaning apparatus 10 executes the automatic cleaning process. Thereby, the detection part 531 is cleaned. As a result, the detection accuracy level of the vehicle-installed sensor 53 increases.

Thereby, the detection part 531 is cleaned at the relatively high detection accuracy level of the vehicle-installed sensor 53 when the vehicle 100 moves in the second area A/Therefore, the high detection accuracy level of the vehicle-installed sensor 53 can be ensured when the vehicle 100 moves in the braking area Abrk. Thus, the driver can accurately recognize the situation behind the vehicle 100 by the inner mirror 61 when the vehicle 100 moves in the braking area Abrk.

<Manual Cleaning>

When (i) the manual cleaning switch 63 is operated, and (ii) the vehicle 100 moves in the third area A3, the vehicle-installed sensor cleaning apparatus 10 determines that a manual cleaning condition is not satisfied. When the vehicle-installed sensor cleaning apparatus 10 determines that the manual cleaning condition is not satisfied, the vehicle-installed sensor cleaning apparatus 10 does not execute a manual cleaning process to inject the cleaning liquid from the cleaning liquid injection device 72 to the detection part 531 of the vehicle-installed sensor 53. In other words, the vehicle-installed sensor cleaning apparatus 10 forbids executing the manual cleaning process when (i) the manual cleaning switch 63 is operated, and (ii) the vehicle 100 moves in the third area A3.

On the other hand, when (i) the manual cleaning switch 63 is operated, and (ii) the vehicle 100 moves in the first area A1 or the second area A2, the vehicle-installed sensor cleaning apparatus 10 determines that the manual cleaning condition becomes satisfied. When the vehicle-installed sensor cleaning apparatus 10 determines that the manual cleaning condition becomes satisfied, the vehicle-installed sensor cleaning apparatus 10 executes the manual cleaning process. In other words, the vehicle-installed sensor cleaning apparatus 10 permits to execute the manual cleaning process when (i) the manual cleaning switch 63 is operated, and (ii) the vehicle 100 moves in the first area A1 or the second area A2.

Thereby, when the vehicle 100 moves in the first area A1 or the second area A2, the manual cleaning process is executed. Thus, the high detection accuracy level of the vehicle-installed sensor 53 can be ensured while the 100 moves in the braking area Abrk.

The vehicle-installed sensor cleaning apparatus 10 may be configured to determine that the automatic cleaning condition is not satisfied, independently of the accuracy index value P when the vehicle 100 moves in the first area A1. Thereby, the total amount of the consumed cleaning liquid can be further reduced.

When the vehicle 100 stops, there may be a walking person around the vehicle 100. If the automatic cleaning process is executed when the walking person is around the vehicle 100, the cleaning liquid may spatter to the walking person. Accordingly, the vehicle-installed sensor cleaning apparatus 10 may be configured not to perform determining whether the automatic cleaning condition is satisfied when the vehicle 100 stops, i.e., when the moving speed of the vehicle 100 is zero. Thereby, the automatic cleaning process is not executed when the vehicle 100 stops. Thus, the cleaning liquid can be prevented from spattering to the walking person. In this case, the vehicle-installed sensor cleaning apparatus 10 is configured to perform determining whether the automatic cleaning condition is satisfied when the vehicle 100 moves, i.e. when the moving speed of the vehicle 100 is larger than zero.

When there is another vehicle coming to the vehicle 100 from behind the vehicle 100 at a moving speed larger than or equal to a predetermined moving speed, the driver may seek to visually recognize the other vehicle by the inner mirror 61. Accordingly, the vehicle-installed sensor cleaning apparatus 10 may be configured to set the predetermined determination threshold Pth to a larger value when a following vehicle condition that there is another vehicle coming to the vehicle 100 from behind the vehicle 100 at the moving speed larger than or equal to the predetermined moving speed, is satisfied. In particular, the vehicle-installed sensor cleaning apparatus 10 may be configured to set the predetermined determination threshold Pth of the first threshold P1 to a larger value when (i) the vehicle 100 moves in the first area A1, and (ii) the following vehicle condition becomes satisfied. In other words, the vehicle-installed sensor cleaning apparatus 10 may be configured to change the automatic cleaning condition to be satisfied at the relatively high detection accuracy level of the vehicle-installed sensor 53 when the following vehicle condition becomes satisfied. Hereinafter, a vehicle coming to the vehicle 100 from behind the vehicle 100 at the moving speed larger than or equal to the predetermined moving speed, will be referred to as “the rapidly-approaching following vehicle.”

When the automatic cleaning process is executed, the image displayed in the inner mirror 61 becomes smudgy temporarily. As a result, it is difficult for the driver to visually recognize the rapidly-approaching following vehicle by the inner mirror 61 until cleaning the detection part 531 is finished. Therefore, when (i) a distance between the rapidly-approaching following vehicle and the vehicle 100 is short, and (ii) the automatic cleaning process is executed, the driver cannot easily visually recognize the rapidly-approaching following vehicle despite a high necessity for the driver to visually recognize the rapidly-approaching following vehicle by the inner mirror 61. Accordingly, the vehicle-installed sensor cleaning apparatus 10 may be configured to set the predetermined determination threshold Pth to a larger value when (i) the following vehicle condition becomes satisfied, and (ii) the distance between the rapidly-approaching following vehicle and the vehicle 100 is longer than or equal to a predetermined distance. In this case, the vehicle-installed sensor cleaning apparatus 10 may be configured to maintain the predetermined determination threshold Pth or set the predetermined determination threshold Pth to a smaller value when (i) the following vehicle condition becomes satisfied, and (ii) the distance between the rapidly-approaching following vehicle and the vehicle 100 is shorter than the predetermined distance.

### Modified Example

Next, the operations of the vehicle-installed sensor cleaning apparatus 10 according to a modified example of the embodiment of the invention will be described. The vehicle-installed sensor cleaning apparatus 10 according to the modified example sets the predetermined determination threshold Pth to the first threshold P1 even when the vehicle 100 moves in the second area A2. Then, the vehicle-installed sensor cleaning apparatus 10 according to the modified example sets the predetermined determination threshold Pth to the second threshold P2 when the vehicle 100 enters in the third area A3 from the second area A2 and determines whether the accuracy index value P is smaller than or equal to the second threshold P2. Immediately after the vehicle-installed sensor cleaning apparatus 10 determines whether P is smaller than or equal to the second threshold P2, the vehicle-installed sensor cleaning apparatus 10 sets the predetermined determination threshold Pth to the third threshold P3.

Thereby, the predetermined determination threshold Pth is set to a larger value only at a point of time when the vehicle 100 enters in the third area A3 from the second area A2. As a result, the automatic cleaning condition is satisfied at the relatively high detection accuracy level of the vehicle-installed sensor 53 only at the point of time when the vehicle 100 enters in the third area A3 from the second area A2. Thus, the total amount of the consumed cleaning liquid can be reduced.

<Concrete Operations of Vehicle-Installed Sensor Cleaning Apparatus>

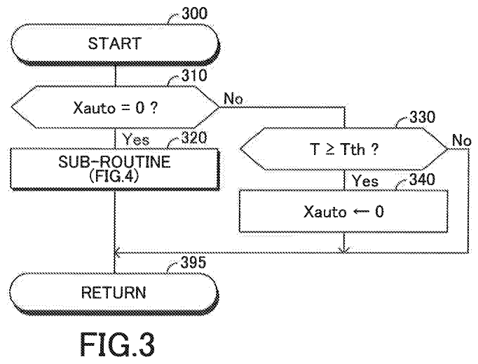

Next, concrete operations of the vehicle-installed sensor cleaning apparatus 10 will be described. The CPU of the ECU 90 of the vehicle-installed sensor cleaning apparatus 10 is configured or programmed to execute a routine shown in FIG. 3 each time a predetermined time elapses.

Therefore, at a predetermined timing, the CPU starts to execute a process from a step 300 in FIG. 3 and proceeds with the process to a step 310 to determine whether a value of an automatic cleaning flag Xauto is “0.” The value of the automatic cleaning flag Xauto is set to “1” when the cleaning liquid is injected from the cleaning liquid injection device 72 by the automatic cleaning process. On the other hand, the value of the automatic cleaning flag Xauto is set to “0” when a predetermined amount of time Tth elapses since the cleaning liquid is injected from the cleaning liquid injection device 72 by the automatic cleaning process. The predetermined amount of time Tth is set to an amount of time required to finish cleaning the detection part 531. The predetermined amount of time Tth is acquired by experiments and has been preliminarily memorized in the ROM of the ECU 90.

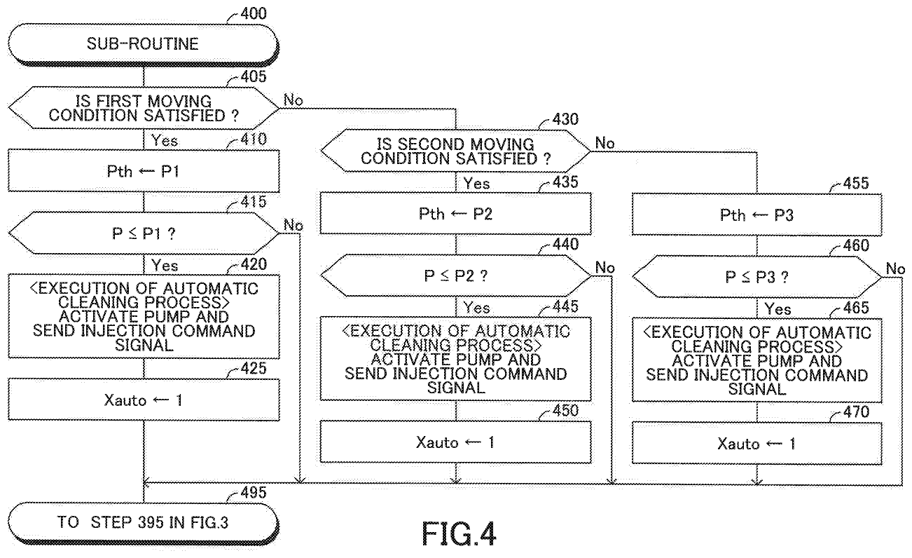

When the CPU determines “Yes” at the step 310, the CPU proceeds with the process to a step 320 to execute a routine shown in FIG. 4. Therefore, when the CPU proceeds with the process to the step 320, the CPU starts to execute the process from a step 400 in FIG. 4 and proceeds with the process to a step 405 to determine whether a first moving condition is satisfied. The first moving condition is satisfied when the vehicle 100 moves in the first area A1.

When the CPU determines “Yes” at the step 405, the CPU proceeds with the process to a step 410 to set the predetermined determination threshold Pth to the first threshold P1. Next, the CPU proceeds with the process to a step 415 to determine whether the accuracy index value P is smaller than or equal to the first threshold P1.

When the CPU determines “Yes” at the step 415, the CPU proceeds with the process to a step 420 to execute the automatic cleaning process. In particular, the CPU activates the pump 71 and sends an injection command signal Sinj to the cleaning liquid injection device 72. When the cleaning liquid injection device 72 receives the injection command signal Sinj, the cleaning liquid injection device 72 activates. Thereby, the cleaning liquid is injected to the detection part 531 of the vehicle-installed sensor 53 from the cleaning liquid injection device 72, and the detection part 531 is cleaned.

Next, the CPU proceeds with the process to a step 425 to set the value of the automatic cleaning flag Xauto to “1.” Then, the CPU proceeds with the process to a step 395 in FIG. 3 via a step 495 to terminate executing this routine once.

On the other hand, when the CPU determines “No” at the step 415, the CPU proceeds with the process to the step 395 in FIG. 3 via the step 495 to terminate executing this routine once.

When the CPU determines “No” at the step 405, the CPU proceeds with the process to a step 430 to determine whether a second moving condition is satisfied. The second moving condition is satisfied when the vehicle 100 moves in the second area A2.

When the CPU determines “Yes” at the step 430, the CPU proceeds with the process to a step 435 to set the predetermined determination threshold Pth to the second threshold P2. Next, the CPU proceeds with the process to a step 440 to determine whether the accuracy index value P is smaller than or equal to the second threshold P2.

When the CPU determines “Yes” at the step 440, the CPU proceeds with the process to a step 445 to execute the automatic cleaning process. In particular, the CPU activates the pump 71 and sends the injection command signal Sinj to the cleaning liquid injection device 72. When the cleaning liquid injection device 72 receives the injection command signal Sinj, the cleaning liquid injection device 72 activates. Thereby, the cleaning liquid is injected to the detection part 531 of the vehicle-installed sensor 53 from the cleaning liquid injection device 72, and the detection part 531 is cleaned.

Next, the CPU proceeds with the process to a step 450 to set the value of the automatic cleaning flag Xauto to “1.” Then, the CPU proceeds with the process to the step 395 in FIG. 3 via the step 495 to terminate executing this routine once.

On the other hand, when the CPU determines “No” at the step 440, the CPU proceeds with the process to the step 395 in FIG. 3 via the step 495 to terminate executing this routine once.

When the CPU determines “No” at the step 430, the CPU proceeds with the process to a step 455 to set the predetermined determination threshold Pth to the third threshold P3. Next, the CPU proceeds with the process to a step 460 to determine whether the accuracy index value P is smaller than or equal to the third threshold P3.

When the CPU determines “Yes” at the step 460, the CPU proceeds with the process to a step 465 to execute the automatic cleaning process. In particular, the CPU activates the pump 71 and sends the injection command signal Sinj to the cleaning liquid injection device 72. When the cleaning liquid injection device 72 receives the injection command signal Sinj, the cleaning liquid injection device 72 activates. Thereby, the cleaning liquid is injected to the detection part 531 of the vehicle-installed sensor 53 from the cleaning liquid injection device 72, and the detection part 531 is cleaned.

Next, the CPU proceeds with the process to a step 470 to set the value of the automatic cleaning flag Xauto to “1.” Then, the CPU proceeds with the process to the step 395 in FIG. 3 via the step 495 to terminate executing this routine once.

On the other hand, when the CPU determines “No” at the step 460, the CPU proceeds with the process to the step 395 in FIG. 3 via the step 495 to terminate executing this routine once.

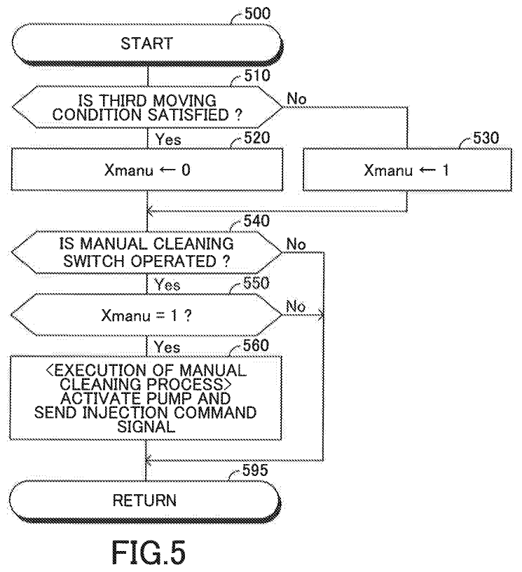

Further, the CPU is configured or programmed to execute a routine shown in FIG. 5 each time the predetermined time elapses. Therefore, at a predetermined timing, the CPU starts a process from a step 500 in FIG. 5 and proceeds with the process to a step 510 to determine whether a third moving condition is satisfied. The third moving condition is satisfied when the vehicle 100 moves in the third area A3.

When the CPU determines “Yes” at the step 510, the CPU proceeds with the process to a step 520 to set a value of a manual permission flag Xmanu to “0.” Next, the CPU proceeds with the process to a step 540.

On the other hand, when the CPU determines “No” at the step 510, the CPU proceeds with the process to a step 530 to set the value of the manual permission flag Xmanu to “1.” Next, the CPU proceeds with the process to a step 540.

When the CPU proceeds with the process to the step 540, the CPU determines whether the manual cleaning switch 63 is operated by the driver.

When the CPU determines “Yes” at the step 540, the CPU proceeds with the process to a step 550 to determine whether the value of the manual permission flag Xmanu is “1.”

When the CPU determines “Yes” at the step 550, the CPU proceeds with the process to a step 560 to execute the manual cleaning process. In particular, the CPU activates the pump 71 and sends the injection command signal Sinj to the cleaning liquid injection device 72. When the cleaning liquid injection device 72 receives the injection command signal Sinj, the cleaning liquid injection device 72 activates. Thereby, the cleaning liquid is injected to the detection part 531 of the vehicle-installed sensor 53 from the cleaning liquid injection device 72, and the detection part 531 is cleaned.

Then, the CPU proceeds with the process to a step 595 to terminate executing this routine once.

On the other hand, when the CPU determines “No” at the step 550, the CPU proceeds with the process to the step 595 to terminate executing this routine once.

Also, when the CPU determines “No” at the step 540, the CPU proceeds with the process to the step 595 to terminate executing this routine once.

According to the routines shown in FIG. 3 and FIG. 4 executed by the vehicle-installed sensor cleaning apparatus 10, the automatic cleaning condition is satisfied at the relatively high detection accuracy level of the vehicle-installed sensor 53 when the vehicle 100 moves in the second area A2. Therefore, the high detection accuracy level of the vehicle-installed sensor 53 can be ensured when the vehicle 100 moves in the braking area Abrk.

It should be noted that the invention is not limited to the aforementioned embodiments, and various modifications can be employed within the scope of the invention.

What is claimed is:

1. A vehicle-installed sensor cleaning apparatus applied to an own vehicle installed with a vehicle-installed sensor, comprising an electronic control unit configured to execute an automatic cleaning process to clean a detection part of the vehicle-installed sensor by a cleaning liquid when an automatic cleaning condition becomes satisfied, wherein:
the electronic control unit is configured to:
obtain information on a present position of the own vehicle as vehicle information; and
perform a changing process to change the automatic cleaning condition, depending on the vehicle information.

2. The vehicle-installed sensor cleaning apparatus as set forth in claim 1, wherein:
the automatic cleaning condition is a condition that an accuracy index value representing a detection accuracy level of the vehicle-installed sensor is smaller than or equal to a predetermined determination threshold; and
the changing process is a process to change the predetermined determination threshold, depending on the vehicle information.

3. The vehicle-installed sensor cleaning apparatus as set forth in claim 1, wherein:
the vehicle information includes a traffic light distance between (i) the present position of the own vehicle and (ii) a traffic light regulating a moving of the own vehicle.

4. The vehicle-installed sensor cleaning apparatus as set forth in claim 3, wherein:
the electronic control unit is configured to obtain the traffic light distance, based on a traffic light installation signal transmitted from a transmitter and representing that the traffic light is installed.

5. The vehicle-installed sensor cleaning apparatus as set forth in claim 1, wherein:
the vehicle information includes a traffic light distance between (i) the present position of the own vehicle and (ii) a traffic light regulating a moving of the own vehicle;
the automatic cleaning condition is a condition that an accuracy index value representing a detection accuracy level of the vehicle-installed sensor is smaller than or equal to a predetermined determination threshold;
the changing process is a process to change the predetermined determination threshold, depending on the traffic light distance; and
the electronic control unit is configured to:
set a first threshold as the predetermined determination threshold when the traffic light distance is longer than or equal to a first distance;
set a second threshold larger than the first threshold as the predetermined determination threshold when the traffic light distance is shorter than the first distance and longer than or equal to a second distance; and
set a third threshold smaller than the first threshold as the predetermined determination threshold when the traffic light distance is shorter than the second distance.

6. The vehicle-installed sensor cleaning apparatus as set forth in claim 5, wherein:
the electronic control unit is configured to determine that the traffic light distance is longer than or equal to the first distance when the electronic control unit does not receive a traffic light installation signal transmitted from a transmitter and representing that the traffic light is installed.

7. The vehicle-installed sensor cleaning apparatus as set forth in claim 5, wherein:
the electronic control unit is configured to:
determine that the traffic light distance is longer than or equal to the first distance when the electronic control unit does not receive a traffic light installation signal transmitted from a transmitter and representing that the traffic light is installed;
determine that the traffic light distance is shorter than the first distance and longer than or equal to the second distance when (i) the electronic control unit receives the traffic light installation signal, and (ii) a distance which the own vehicle has moved since the electronic control unit starts to receive the traffic light installation signal, is shorter than or equal to a predetermined distance; and
determine that the traffic light distance is shorter than the second distance when the distance which the own vehicle has moved since the electronic control unit starts to receive the traffic light installation signal, is longer than the predetermined distance.

8. The vehicle-installed sensor cleaning apparatus as set forth in claim 5, wherein:
the electronic control unit is configured to execute a manual cleaning process to clean the detection part by the cleaning liquid when (i) the traffic light distance is longer than or equal to the second distance, and (ii) a switch to request to clean the detection part is operated.

9. The vehicle-installed sensor cleaning apparatus as set forth in claim 1, wherein:
the vehicle information includes a traffic light distance between (i) the present position of the own vehicle and (ii) a traffic light regulating a moving of the own vehicle; and
the automatic cleaning condition is a condition that (i) the traffic light distance is shorter than a first distance, and (ii) an accuracy index value representing a detection accuracy level of the vehicle-installed sensor is smaller than or equal to a predetermined determination threshold.

10. The vehicle-installed sensor cleaning apparatus as set forth in claim 1, wherein:
the vehicle information includes an area distance between (i) the present position of the own vehicle and (ii) an area where a detection accuracy level of the vehicle-installed sensor higher than or equal to a predetermined accuracy level is required.

11. The vehicle-installed sensor cleaning apparatus as set forth in claim 10, wherein:
the area is an area where the own vehicle is presumed to be braked.

12. The vehicle-installed sensor cleaning apparatus as set forth in claim 1, wherein:
the vehicle information includes an area distance between (i) the present position of the own vehicle and (ii) an area where a detection accuracy level of the vehicle-installed sensor higher than or equal to a predetermined accuracy level is required;
the automatic cleaning condition is a condition that an accuracy index value representing a detection accuracy level of the vehicle-installed sensor is smaller than or equal to a predetermined determination threshold;
the changing process is a process to change the predetermined determination threshold, depending on the area distance; and
the electronic control unit is configured to:
set a first threshold as the predetermined determination threshold when the area distance is longer than or equal to a first distance;
set a second threshold larger than the first threshold as the predetermined determination threshold when the area distance is shorter than the first distance and longer than or equal to a second distance; and
set a third threshold smaller than the first threshold as the predetermined determination threshold when the area distance is shorter than the second distance.

13. The vehicle-installed sensor cleaning apparatus as set forth in claim 1, wherein:
the vehicle information includes an area distance between (i) the present position of the own vehicle and (ii) an area where a detection accuracy level of the vehicle-installed sensor higher than or equal to a predetermined accuracy level is required; and
the automatic cleaning condition is a condition that (i) the area distance is shorter than a first distance, and (ii) an accuracy index value representing the detection accuracy level of the vehicle-installed sensor is smaller than or equal to a predetermined determination threshold.

14. The vehicle-installed sensor cleaning apparatus as set forth in claim 1, wherein:
the vehicle information includes an area distance between (i) the present position of the own vehicle and (ii) an area where a detection accuracy level of the vehicle-installed sensor higher than or equal to a predetermined accuracy level is required;
the automatic cleaning condition is a condition that an accuracy index value representing a detection accuracy level of the vehicle-installed sensor becomes smaller than or equal to a predetermined determination threshold;
the changing process is a process to change the predetermined determination threshold, depending on the area distance; and
the electronic control unit is configured to:
set a first threshold as the predetermined determination threshold when the area distance is longer than or equal to a distance presumed for the own vehicle to move until cleaning the detection part is finished; and
set a second threshold larger than the first threshold as the predetermined determination threshold when the area distance becomes equal to the distance presumed for the own vehicle to move until cleaning the detection part is finished and immediately afterwards, set a third threshold smaller than the first threshold as the predetermined determination threshold.

15. The vehicle-installed sensor cleaning apparatus as set forth in claim 1, wherein:
the electronic control unit is configured to:
determine whether the automatic cleaning condition is satisfied when the own vehicle moves; and
stop determining whether the automatic cleaning condition is satisfied when the own vehicle is stopped.

16. The vehicle-installed sensor cleaning apparatus as set forth in claim 1, wherein:
the vehicle-installed sensor is a sensor which detects a situation behind the own vehicle; and
the electronic control unit is configured to change the automatic cleaning condition to be satisfied at a higher detection accuracy level of the vehicle-installed sensor when the vehicle-installed sensor detects a following vehicle which approaches the own vehicle from behind the own vehicle at a moving speed higher than or equal to a predetermined moving speed.
